(19) United States
(12) Patent Application Publication
(10) Pub. No.: US 2003/0181111 A1
(43) Pub. Date: Sep. 25, 2003

(54) Hose and pipe reinforcement

(76) Inventors: Willy De Meyer, Drongen (BE); Mark Faket, Gent (BE); Willy Remi Faket, Itterbeek (BE)

Correspondence Address: MILLIKEN & COMPANY, 920 MILLIKEN RD, PO BOX 1926, SPARTANBURG, SC, 29304, US

(21) Appl. No.: 10/203,045

(22) PCT Filed: Feb. 8, 2001
(86) PCT No.: PCT/EP01/01362

(30) Foreign Application Priority Data
Feb. 8, 2000 (GB) 0002739.1

(51) Int. Cl. D03D 15/00

(52) U.S. Cl. 442/59; 442/208

(57) ABSTRACT

The invention relates to a reinforcement fabric for use in manufacture of hoses and pipes having a body matrix of polymer material, said reinforcement fabric comprising a collection of substantially parallel reinforcement yarns arranged along a longitudinal direction of the fabric and a plurality of transverse and/or bias yarns interconnecting the reinforcement yarns. The reinforcement fabric is a stable fabric for direct application to the polymer body matrix of a preform of the hose or pipe by wrapping the reinforcement fabric around the preform. The reinforcement fabric is adapted to be directly applied to the polymer body matrix of the preform by the transverse and/or bias yarns being substantially lighter than the reinforcement yarns, and by at least one surface of the reinforcement fabric being tackified for adhesion to the polymer body matrix of the preform of the hose or pipe.

The present invention relates to the reinforcement of polymer and rubber products such as flexible hoses for pneumatic and hydraulic applications. It will be appreciated, however, that the invention is also applicable to the reinforcement of relatively rigid pipes formed from polymer material. The present invention in particular relates to the use of a special fabric for reinforcing hoses and pipes.

Rubber products such as vehicle tyres and hydraulic hoses are known to be reinforced with what is called “tyre cord”. Tyre cord generally comprises a plurality of parallel textile cords or “ends” which are embedded in sheet rubber in a calendering process to create a reinforcement product which is then suitable for application to a tyre or hose pre-form. The embedding of the cords in the rubber sheet is necessary to place the cords in a stable and robust form and to facilitate their subsequent handling.

The calendering process itself is a relatively labour-intensive and energy-intensive operation and typically results in waste of both the cords and the rubber sheeting. In particular, there are usually material losses at the edges and at either end of each calendering production run. Accordingly, it would be highly desirable to provide a new, substitute reinforcement product and method which does not require the traditional calendering operation. The present invention aims to provide just such a product and method.

GB-2335 251 discloses a spoolable composite tube comprising a substantially fluid impervious inner liner formed from polymeric or metallic material, and a first composite layer 14 enclosing said liner and formed of fiber and matrix, said first composite layer having first 20, second 16 and third 18 fibers extending helically, wherein the second fiber extends clockwise and the third fiber extends counter clockwise, such that said first fiber is interwoven with at least one of said second fiber and said third fiber.

According to one aspect the present invention provides a reinforcement fabric for use in manufacture of hoses and pipes having a body matrix of polymer material, said reinforcement fabric comprising a collection of substantially parallel reinforcement yarns arranged along a longitudinal direction of the fabric and a plurality of transverse and/or bias yarns interconnecting the reinforcement yarns. The reinforcement fabric is a stable fabric for direct application to the polymer body matrix of a preform of the hose or pipe by wrapping the reinforcement fabric around the preform. The reinforcement fabric is adapted to be directly applied to the polymer body matrix of the preform by the transverse and/or bias yarns being substantially lighter than the reinforcement yarns, and by at least one surface of the reinforcement fabric being tackified for adhesion to the polymer body matrix of the preform of the hose or pipe. The term “adhesion” as used herein does not mean that a particularly strong bond between the polymer body matrix of the preform and the reinforcement fabric is to be achieved, instead the term “adhesion” is used to denote a certain amount of stickiness that is needed to hold the reinforcement fabric in place on the preform of the hose or pipe during subsequent manufacturing operations.

In addition to tackifying the at least one surface of the reinforcement fabric a chemical finish may be applied to the longitudinal reinforcement yarns or the entire reinforcement fabric to ensure a strong bond of the reinforcement yarns to the polymer body matrix of the hose or pipe after full manufacture of the hose or pipe. The chemical finish can be applied before or simultaneously to the tackifying operation.

The reinforcement yarns of the invention are typically arranged as warp in the fabric while the interconnecting yarns are typically arranged as transverse weft, and/or as bias yarns which extend at an angle to the warp. The reinforcement yarns are typically relatively heavy cords, while the interconnecting yarns are substantially lighter, and may be as light as simple threads. In the context of the present invention, “lighter” means that there is much less weight in the transverse and/or bias yarns than the longitudinal reinforcement yarns. This typically results in the transverse and/or bias yarns having a considerably lesser tensile strength than the reinforcement yarns.

The reinforcement yarns or cords may be any of a variety of natural and synthetic yarns or monofilament, and are preferably formed from any one or more of nylon, polyester, polyethylene, polypropylene, aramid, PVA, rayon, cotton, carbon, metal or glass. The composition of the weft and/or bias yarns is not critical and practically any type capable of holding the reinforcing cord securely in the fabric will suffice. Furthermore, in contrast to the traditional tyre cord, the reinforcement yarns in the fabric of the invention are preferably low twist yarns. These provide lower elasticity and consequently exhibit less elongation in pressurised hose applications.

The reinforcement fabric may be tackified at just one surface, but is more preferably tackified at both. For example, the entire fabric may have been impregnated with a tackifying substance. In this context, and as known in the art, a tackified surface is a surface that will stick to another surface by a light pressure. In a particular preferred form of the invention the yarns of the reinforcement fabric are tackified by application of a coating which enhances the overall stability of the fabric and/or promotes adhesion of the fabric to the polymer matrix of the hose or pipe pre-form upon formation/building of the hose or pipe pre-form. The coating substance itself is preferably a liquid equivalent to or compatible to the polymer of the hose. The coating operation of the fabric may be performed by means of dipping or spraying the complete fabric. Alternatively, the reinforcing yarns may themselves have been individually treated or coated before their incorporation in the reinforcing fabric.

The reinforcement fabric may be formed according to a variety of known fabric constructions, including woven, knitted, laid, braided, stitched, sewed and non-woven constructions. In a preferred embodiment of the invention the fabric has woven or knitted weft yarns/threads. The fabric may possibly also include weft insertion. In another particularly preferred embodiment, the reinforcement fabric has a laid construction, with the yarns collectively treated so that they bond together in the fabric. This treatment of the yarns may also be a coating operation. Most preferably, the coating of the laid yarns serves to both bond the laid yarns into a relatively robust laid fabric construction and to also render the fabric tacky, i.e. suitably adhesive to the polymer matrix of the hose pre-form for its direct application thereto.

The reinforcement fabric of the invention is, due to its novel construction, inherently stable and thus allows to slit the fabric into tape form. Accordingly, the reinforcement fabric of the invention is preferably provided slit into reels of fabric strip or tape, with the reinforcement yarns or cords extending longitudinally of the strip. In use, the fabric strip of the invention is wrapped directly around a polymer matrix pre-form of a hose in a substantially circumferential direction. However, the fabric strip may be wrapped at a slight angle to the circumferential direction so that the strip traverses a length of the hose or pipe in a helical fashion. The tackifying helps to maintain the integrity of the fabric strips after slitting the reinforcement fabric.

According to another aspect the invention provides a method of producing a stable reinforcement fabric to be wrapped directly around a polymer body matrix of a hose or pipe pre-form, the method comprising the steps of:

arranging a plurality of reinforcement yarns substantially side by side as warp of the fabric,

arranging a plurality of weft and/or bias yarns that are substantially lighter than the reinforcement yarns to interconnect said plurality of reinforcement yarns with said plurality of weft and/or bias yarns, and

tackifying at least one surface of the reinforcement fabric such that the reinforcement fabric sticks to the polymer body matrix of the preform of the hose or pipe.

According to a further aspect, the present invention provides a method of reinforcing a hose or pipe formed from polymer material, comprising the steps of:

providing an elongate strip of reinforcement fabric according to the invention as described above;

providing a pre-form of said hose or pipe, comprising a matrix of said polymer material; and

applying the reinforcement fabric directly to the polymer matrix of the pre-form by wrapping the elongate fabric strip in a substantially circumferential direction around the pre-form.

The width of the strip of reinforcing fabric will generally depend on the pre-form diameter at which the fabric is applied. For example, the width (w) of the strip preferably lies within the range of 0,50πd and 0,90πd, but is most preferably calculated according to the formula:

w=0.705 πd

where w=strip width, and

d=diameter of reinforcement.

According to yet another aspect, the present invention also provides a hose or a pipe formed according to the above method.

For a better understanding of the present invention, a preferred embodiment is hereafter described by way of example. This example may be read with reference to the preceding description, but it is in no way intended to limit the generality of that description.

In one exemplary embodiment of the invention a fabric is provided for the reinforcement of a flexible rubber hose for use in an hydraulic circuit; i.e. a flexible rubber hose to be subjected to substantial internal pressures. The reinforcement fabric is essentially oriented in one direction—the lengthwise or warp direction. The second or weft direction is present merely to keep the main direction together in a regular way. Accordingly, the fabric comprises a plurality of textile reinforcement yarns or cords (e.g. nylon) arranged substantially parallel and relatively densely in the warp of the fabric. A plurality of weft yarns are knitted with the warp reinforcement cord to form the fabric. The second set of yarns (the weft yarns), however, are an order of magnitude lighter than the warp cords and may be significantly more sparsely arranged.

The fabric is adapted to be directly applied to the rubber matrix of the hose. In this regard, the fabric is tackified, to both enhance the independent stability of the fabric and to promote its adhesion to the rubber material when building the hose or pipe. To achieve the tackifying, the fabric may be coated with a liquid substance, for example by dipping or spraying. The coating substance is compatible with the rubber material of the hose. The fabric is slit into elongate strips with the reinforcement warp cords extending longitudinally of the strips.

In fabricating the hose, a first hose pre-form is extruded and the strip of reinforcement fabric is then applied directly to the rubber matrix of the pre-form. The fabric strip is wrapped directly around the pre-form in a substantially circumferential direction, although preferably at a slight angle so that the wrapped reinforcement fabric gradually traverses the length of the hose. The width of the fabric strip is preferably calculated according to the formula: w=0,705 πd, where w is the strip width and d is the diameter of the reinforcement. Further rubber material is then typically extruded over the wrapped reinforcement fabric.

One of the most significant benefits of the present invention is that it enables the previously necessary calendering operation in which tyre cord is embedded in a sheet of rubber to be eliminated. Accordingly, pre-slit reinforcement fabric, which is able to be directly applied to the polymer matrix of a hose can be supplied directly to the hose manufacturers. Furthermore, the present invention is able to provide a more stable and more regular product than before which is tailored to requirements of hose manufacturers.

It will be appreciated that various alterations and/or additions may be made to the particular arrangement and construction of the fabric previously described without departing from the spirit or ambit of the invention as defined in the claims.

1. A reinforcement fabric for use in manufacture of reinforced hoses or reinforced pipes having a body matrix of polymer material, said reinforcement fabric comprising a collection of substantially parallel reinforcement yarns arranged along a longitudinal direction of the fabric and a plurality of transverse and/or bias yarns interconnecting the reinforcement yarns, and said reinforcement fabric being a stable fabric for direct application to the polymer body matrix of a preform of the hose or pipe by wrapping the reinforcement fabric around the preform, wherein the reinforcement fabric is adapted to be directly applied to the polymer body matrix of the preform by
the transverse and/or bias yarns being substantially lighter than the reinforcement yarns, and by
at least one surface of the reinforcement fabric being tackified to stick to the polymer body matrix of the preform of the hose or pipe.

2. A reinforcement fabric as claimed in claim 1 wherein the tensile strength of the transverse and/or bias yarns is substantially less than the tensile strength of the reinforcement yarns.

3. A reinforcement fabric as claimed in claim 1 or claim 2 wherein the tackiness provides for integrating the reinforcement yarns and the transverse and/or bias yarns into a stable fabric.

4. A reinforcement fabric as claimed in any of claims 1 to 3 wherein the tackiness is provided by means of a coating of the yarns.

5. A reinforcement fabric as claimed in any of claims 1 to 4 wherein the fabric is in the form of an elongate strip and wherein the reinforcement yarns extend longitudinally of the strip.

6. A reinforcement fabric as claimed in claim 5 wherein the fabric strip is provided wound on a reel or spool.

7. A reinforcement fabric as claimed in any of the preceding claims wherein the reinforcement yarns comprise any one or more of nylon, polyester, polyethylene, polypropylene, rayon, aramid, PVA, carbon, glass or metal, or other material in yarn form or as monofilament.

8. A reinforcement fabric as claimed in any one of the preceding claims wherein the fabric has a knitted, woven, nonwoven, laid, braided stitched or sewed construction.

9. A method of producing a stable reinforcement fabric to be wrapped directly around a polymer body matrix of a hose or pipe pre-form, the method comprising the steps of:
arranging a plurality of reinforcement yarns substantially side by side as warp of the fabric,
arranging a plurality of weft and/or bias yarns that are substantially lighter than the reinforcement yarns to interconnect said plurality of reinforcement yarns with said plurality of weft and/or bias yarns, and
tackifying at least one surface of the reinforcement fabric such that the reinforcement fabric sticks to the polymer body matrix of the preform of the hose or pipe.

10. A method as claimed in claim 9 wherein the tackifying step involves coating the reinforcement yarns and/or the weft and/or bias yarns before, after or during fabric formation.

11. A method as claimed in claim 9 or 10 wherein the tackifying step involves either one or both of spraying said yarns with a substance in liquid form or dipping said yarns in a bath of said substance.

12. A method as claimed in any one of claims 9 to 11 wherein the yarns are already interconnected, for example by knitting, stitching, sewing or weaving, before the tackifying step.

13. A method as claimed in any one of claims 9 to 11 wherein the step of tackifying the yarns also serves to bond them together within a laid fabric construction.

14. A method as claimed in any one of claims 9 to 13 further including the step of:
slitting the fabric into an elongate strip such that said reinforcement yarns or cords extend longitudinally of said strip, and
winding said strip onto a reel or spool.

15. A method as claimed in claim 14 wherein the strip has a width in the range of 0,50πd to 0,9πd, and preferably 0,705πd, where d is a reinforcement diameter of the hose or pipe.

16. A method of reinforcing a hose or pipe formed from polymer material comprising the steps of:
providing an elongate strip of reinforcement fabric according to any one of claims 1 to 8;
forming a pre-form of said hose or pipe comprising a matrix of said polymer material; and
applying the reinforcement fabric directly to the polymer matrix of the hose or pipe pre-form by wrapping the fabric strip in a substantially circumferential direction around the pre-form.
